(19) United States
(12) Patent Application Publication
(10) Pub. No.: US 2026/0357388 A1
(43) Pub. Date: Nov. 12, 2026

(54) S-CONTAINING STAINLESS STEELS WITH EXCELLENT SURFACE PROPERTIES AND THEIR PRODUCTION METHODS

(71) Applicant: Nippon Yakin Kogyo Co., Ltd., Tokyo (JP)

(72) Inventors: Fumiaki KIRIHARA, Kawasaki City (JP); Kazuki MIYAMOTO, Kawasaki City (JP)

(73) Assignee: Nippon Yakin Kogyo Co., Ltd., Tokyo (JP)

(21) Appl. No.: 19/130,770

(22) PCT Filed: Nov. 2, 2023
(86) PCT No.: PCT/JP2023/039669

§ 371 Date: Oct. 7, 2025

(30) Foreign Application Priority Data
Nov. 17, 2022 (JP) 2022-184034

(51) Int. Cl. C22C 33/04; C21D 3/04; C22C 38/00; C22C 38/02; C22C 38/06; C22C 38/42; C22C 38/44; C22C 38/58; C22C 38/60

(52) U.S. Cl. CPC C22C 33/04; C21D 3/04; C22C 38/002; C22C 38/02; C22C 38/06; C22C 38/42; C22C 38/44; C22C 38/58; C22C 38/60; C21D 2211/004

(57) ABSTRACT

The S-containing stainless steel includes, in mass %, C: not greater than 0.30%, Si: 0.2 to 1.0%, Mn: 1.2 to 1.8%, Ni: 5 to 10%, Cr: 15 to 20%, Mo: 0.05 to 0.60%, Cu: 0.05 to 0.60%, Al: not greater than 0.005%, S: 0.15 to 0.25%, Ca: 0.0001 to 0.0010%, Mg: not greater than 0.0010%, 0:0.0020 to less than 0.0080%, Fe as a remainder and inevitable impurities, wherein oxide type inclusions include at least one of CaO—SiO₂—MgO—Al₂O₃—MnO type inclusion and MgO—Al₂O₃—MnO type inclusion, and the MgO—Al₂O₃—MnO type inclusion contains MnO: 1 to 15 mass %. By controlling composition of oxide type inclusion accurately and rendering the oxide type inclusion harmless, S-containing stainless steels excellent surface properties can be provided. In addition, methods for production of the S-containing stainless steels include controlled formation of inclusions and accurately controlled S concentration.

### TECHNICAL FIELD

The present invention relates to S-containing stainless steels having excellent surface properties in which composition of oxide type non-metallic inclusions in molten steel is controlled by controlling deoxidation method and slag composition, so as to render the oxide type inclusions harmless. Furthermore, in the present invention, methods for production of the S-containing stainless steels having excellent surface properties are also proposed, in which formation of inclusions are controlled and that S concentration is also controlled accurately.

### BACKGROUND ART

S-containing stainless steel, such as SUS303 is a steel kind which has improved machinability and cutting ability when it is ground with tools, by containing high concentration of S, being not less than 0.15 mass %, and forming MnS particles. It is widely used for precision parts for machining, and in semiconductor manufacturing equipment, even a small damage on the surface can cause serious problems by losing airtightness. That is, excellent surface properties are required for S-containing stainless steel.

In a refining method for S-containing steels, unlike a method for refining general-purpose stainless steels (for example, SUS304), it is necessary to prevent S added in molten steel from moving to slag. Reaction of S in molten steel and slag can be shown by the reaction formulas 1 to 3. The formula 1 indicates reaction in which S in molten steel reacts with CaO in slag so as to generate CaS, and the formula 2 indicates deoxidation by Si which is a deoxidizing material, and the formula 3 is a formula in which the formulae 1 and 2 are combined. According to the formulae 1 to 3, in order to restrain S moving into slag and to accurately control S concentration, it is obvious that a refining method should be employed, in which CaO concentration in slag is not increased, (CaO)/(SiO₂) ratio is decreased, oxygen concentration in molten steel is not decreased and Si concentration in molten steel is not increased.

However, in such a refining method, although S concentration may be easily controlled and S yield may be improved, number of non-metallic inclusion may be increased and the non-metallic inclusion composition may be MnO—SiO₂ type inclusion having high melting point due to insufficient deoxidation, thereby cause scab damage on the surface of products due to the inclusion. There is a problem in which yield of product may be deteriorated due to removing the scab damage by surface grinding or cutting, and furthermore, there is a problem in which the alloy cannot be used for precision machine parts to which surface properties are strictly required.

(CaO)+S=(CaS)+O formula 1

Si+2O=(SiO₂) formula 2

2(CaO)+2S+Si=2(CaS)+(SiO₂) formula 3

In the above formulae, element in the brackets indicates component in slag and element with under line indicates component in molten steel.

Patent Document 1 discloses austenitic stainless steel in which sulfur is contained at 0.15 to 0.50% and oxygen concentration is controlled to be within a range of 80 to 200 ppm thereby control shape of sulfides after hot processing or hot and cold processing to be granular shape in order to improve machinability. This technique indicates that it is important to render oxides precipitated in the sulfides Si—Mn type oxides. However, since O concentration is controlled to be very high, number of oxide type inclusions may be large, and adverse influence such as cracking or nozzle blocking due to the oxide type inclusions may be concerned.

Furthermore, Patent Document 2 discloses stainless steel having excellent hot workability and machinability in which REM (Rare Earth Metal) is added to control composition of oxides thereby control distribution of sulfides. However, since each of REM is very expensive metal, cost may be increased. Furthermore, since REM is very active metal, if REM is added to molten steel having high oxygen concentration, large amount of REM oxides may be generated and surface properties may be deteriorated. That is, the problem of surface properties in S-containing steel remains even by the technique disclosed in the Patent Document 2.

Furthermore, Patent Document 3 relates to a method for production of S-containing stainless steel and also discloses a method to control S concentration accurately. That is, CaO—SiO₂ type slag in which slag basicity CaO/SiO₂ is controlled to be 1 to 1.5 is formed, S is added at 0.3 mass % to 0.6 mass % thereby control S concentration to be 0.15 to 0.25 mass % finally, and slab is produced by continuous casting. However, there are problems such that addition amount of S is large, cost is increased, and refining needs long time. Furthermore, oxide type inclusions are not considered.

As explained so far, there are many disclosures such as an invention regarding chemical components of austenitic stainless steels having improved machinability and cutting ability, and an invention improving control of sulfides by controlling oxide and improving hot workability; however, there are few inventions focusing on influence by oxide type inclusions themselves. That is, it can be said that the problem of surface properties due to oxide type inclusions in S-containing steels remains.

The Patent Documents are as follows.
Patent Document 1: Japanese Unexamined Patent Application Publication No. Heisei 8 (1996)-260102
Patent Document 2: Japanese Unexamined Patent Application Publication No. 2014-28997
Patent Document 3: Japanese Unexamined Patent Application Publication No. 2014-234543

### SUMMARY OF INVENTION

The present invention is completed in view of the above problems, and an object of the present invention is to provide S-containing stainless steel having excellent surface properties by accurately controlling composition of oxide type inclusions and by rendering the oxide type inclusions harmless. Furthermore, the present invention relates to a method for production of the S-containing stainless steel, and also proposes a refining method in which formation of inclusions are controlled and S concentration is accurately controlled.

The inventors had analyzed various influences which influence surface defects with respect to S-containing stainless steels, based on operation data of S-containing stainless steels produced under various operation conditions. Practically, evaluation was performed on composition and number of inclusions having size not less than 5 μm in a sample collected from a tundish during continuous casting of SUS303, evaluation was performed on appearance of SUS303 plate having plate width 1000 mm and plate thickness 3.0 mm after annealing and acid washing, and analysis was performed on relationship between surface defects having length not less than 1 mm and slag composition or metal composition, and relationship between the surface defects and composition of oxide type inclusions or refining method. Furthermore, analysis was performed on factor which influences S yield and accuracy of control of S concentration.

First, when researching the inclusions in the samples which were collected from the tundish during continuous casting, it became obvious that composition of oxide type inclusions was varied depending on oxygen concentration, MnO—SiO₂ type inclusion was formed if oxygen concentration was high, MgO—Al₂O₃ type inclusion was formed if oxygen concentration was low, and CaO—SiO₂—Al₂O₃—MgO type inclusion was formed if oxygen concentration was intermediate. Furthermore, it became obvious that number of inclusions was large when oxygen concentration was high and MnO—SiO₂ type inclusion was formed as the oxide type inclusion.

Furthermore, as a result of researching surface quality of products, it became obvious that more surface defects were found as MgO—Al₂O₃ type inclusion and MnO—SiO₂ type inclusion were contained more among oxide type inclusions. This reason became obvious that these oxide type inclusions had high melting point, adhered on the surface of refractory of immerse nozzle used in continuous casting, became aggregation by sintering, and fell off after being coarsened, and that the coarsened oxide type inclusions which were generated may be origin point of surface defect during hot rolling. Furthermore, since number of MnO—SiO₂ type inclusion is large, it may cause increased surface defects. Furthermore, it also became obvious that since CaO—SiO₂—Al₂O₃—MgO type inclusion forms fine inclusion on the surface of products, and it unlikely forms surface defects on the surface of products.

Furthermore, the inventors found that surface defects are reduced if CaO—SiO₂—Al₂O₃—MgO type inclusion contained MnO. This is because if CaO—SiO₂—Al₂O₃—MgO type inclusion contains MnO, melting point of the oxide type inclusion may be decreased, the inclusion is stretched, divided and rendered fine during hot rolling, thereby prevent surface defects on the surface of products.

Furthermore, the inventors found that surface defects were reduced if MgO—Al₂O₃ type inclusion contained MnO. MgO—Al₂O₃ type inclusion is an oxide type inclusion which easily adheres on the surface of refractory of immerse nozzle used in continuous casting, becomes aggregation by sintering, is coarsened, and falls off thereby cause coarsened oxide type inclusion which may be origin point of surface defect during hot rolling; however, it became obvious that effect was obtained in which liquid phase oxide of low melting point containing MnO was generated around MgO—Al₂O₃ type inclusion at 1600 °C of refining temperature, adhered on the surface of refractory of immerse nozzle and then did not form aggregation even by sintering thereby reduce coarsening, if MgO—Al₂O₃ type inclusion contains MnO.

Based on the above-mentioned knowledges, it became obvious that in order to improve surface properties of S-containing steels, it was desirable that oxygen level in molten steel was controlled so that oxide type inclusions were controlled to be CaO—SiO₂—Al₂O₃—MgO—MnO type inclusion or MgO—Al₂O₃—MnO type inclusion. In particular, the CaO—SiO₂—Al₂O₃—MgO—MnO type inclusion is desirable. Oxide type inclusions which should be avoided is MnO—SiO₂ type inclusion and MgO—Al₂O₃ type inclusion.

However, it is necessary to decrease oxygen level in order to control oxide type inclusions to be CaO—SiO₂—Al₂O₃—MgO—MnO type inclusion or Al₂O₃—MgO—MnO type inclusion, and if oxygen level is decreased, since S which is added may be moved from molten steel to slag according to the formulae 1 to 3, yield of S may be deteriorated, and S may be needed to add to reach target component value. As a result, there is a problem in which refining takes long time. Then, the inventors have researched reaction between molten steel and slag from viewpoints of equilibrium theory and kinetic theory, and as a result, they completed development of refining method in which both control of oxide type inclusion to be a desirable composition and control of S concentration in molten steel are performed rapidly. Hereinafter the developed refining method is explained.

A component which plays one of the most important roles in the developed refining method is MgO component in slag. After deoxidizing by Si or Si+Al, lime is added to generate CaO—SiO₂—MnO type slag, and furthermore, MgO is added so that MgO is contained at 25 to 45 mass %. By adding MgO, slag becomes solid phase consisting of MgO phase, MgO—SiO₂ phase and CaO—MgO phase, and liquid phase containing CaO—SiO₂—MnO as the main component.

It became obvious that by generating the solid phase consisting of MgO phase, MgO—SiO₂ phase and CaO—MgO phase by adding MgO in slag, effect was obtained in which amount of CaO in the liquid phase slag which reacted with S in molten steel was reduced, S which was added in the molten steel was easily yielded in the molten steel. That is, the reaction shown by the formula 3 promotes to the right direction; however, since amount of CaO in the liquid phase slag is small, CaS in the slag is saturated and the reaction does not promote any longer. That is, by adding MgO, since S which is added is easily yielded in the molten steel, S concentration can be controlled rapidly and accurately even if oxygen concentration is reduced.

Furthermore, it became obvious that by generating the solid phase consisting of MgO phase, MgO—SiO₂ phase and CaO—MgO phase by adding MgO in the slag, effect was obtained in which part of CaO and SiO₂ were moved to the solid phase, MnO concentration was relatively increased in the liquid phase slag, and MnO concentration was increased in oxide type inclusions existing in the molten steel which was at equilibrium condition with the liquid phase.

Furthermore, the inventors found that an adding method of a deoxidizing material had a large influence on controlling composition of oxide inclusions. Targets of the deoxidizing material in the S-containing stainless steel of the present invention are Si, Mn, and Al, and the inventors found that effect was obtained in which MnO was contained in CaO—SiO₂—Al₂O₃—MgO—MnO type inclusion or MgO—Al₂O₃—MnO type inclusion by adding Mn to the molten steel first after decarburization. The effect which is obtained by adding Mn first is explained.

By adding Mn first, to molten steel in which oxygen concentration is high after decarburization, Mn is oxidized, oxide type inclusion mainly containing MnO is generated in the molten steel, and MnO concentration in slag is also increased. After that, even if MnO is reduced by adding Si or Al, MnO in oxide type inclusion and MnO in the slag may remain. On the other hand, in a case in which Si or Al is added first, since deoxidizing power of Si and Al is greater than that of Mn, Mn which is added later may be oxidized at only slight amount, MnO in oxide type inclusion may be low.

As explained above, in order to improve surface properties of S-containing steel, the inventors had developed the refining method in which oxygen level in molten steel was controlled, oxide type inclusions were controlled to be CaO—SiO₂—Al₂O₃—MgO—MnO type inclusion or Al₂O₃—MgO—MnO type inclusion, and S concentration in the molten steel was rapidly controlled at the same time.

Next, as explained above, the inventors had further proceeded analysis regarding appropriate range of oxygen concentration and kinds of operation conditions in order to control to be the appropriate range, and as a result, the present invention was completed. That is, the aspect of the present invention is a S-containing stainless steel having excellent surface properties consisting of, in mass %, C: not greater than 0.30%, Si: 0.2 to 1.0%, Mn: 1.2 to 1.8%, Ni: 5 to 10%, Cr: 15 to 20%, Mo: 0.05 to 0.60%, Cu: 0.05 to 0.60%, Al: not greater than 0.005%, S: 0.15 to 0.25%, Ca: 0.0001 to 0.0010%, Mg: not greater than 0.0010%, 0:0.0020 to less than 0.0080%, Fe as a remainder and inevitable impurities, in which oxide type inclusions consists of at least one of CaO—SiO₂—MgO—Al₂O₃—MnO type inclusion and MgO—Al₂O₃—MnO type inclusion, and the MgO—Al₂O₃—MnO type inclusion contains MnO: 1 to 15 mass %.

In addition, it is desirable that among the oxide type inclusions, CaO—SiO₂—MgO—Al₂O₃—MnO type inclusion contains MnO: 1 to 15 mass %.

Furthermore, it is desirable that among the oxide type inclusions, number of the MgO—Al₂O₃—MnO type inclusion is not greater than 50% in number ratio.

In the present invention, the following method for production of the alloy is desirable, that is, the method for production of S-containing stainless steel having excellent surface properties includes steps of: melting raw material in an electric furnace, decarburizing in AOD or VOD, adding Mn, performing Cr reduction using Si, or both of Si and Al, adding lime to control basicity of slag CaO/SiO₂ to be 0.75 to less than 1.00, and further adding MgO source to form CaO—SiO₂—MgO—MnO type slag in which MgO concentration in the slag is controlled to be 25 to 45 mass %.

### EMBODIMENTS OF INVENTION

Reasons for limiting chemical components of the S-containing stainless steel of the present invention are explained. It should be noted that “%” means “mass %” in the following explanation.

C: Not Greater than 0.03 Mass %

C is a useful element to maintain strength; however, if it is contained excessively, sensitization may occur and corrosion resistance may be deteriorated. Therefore, it is set to be not greater than 0.30 mass %. It is desirably not greater than 0.15 mass % and more desirably not greater than 0.07 mass %.

### Si: 0.2 to 1.0 Mass %

Si is an extremely important element in the present invention since it contributes to deoxidation. Since oxygen concentration may be decreased if Si is too high, being greater than 1.0 mass %, the reactions of formulae 1 to 3 may be promoted to right direction. That is, S in molten steel may be moved to slag. Furthermore, by decreasing oxygen concentration in molten steel, Mg may be excessively supplied to molten steel, MgO—Al₂O₃ may be easily generated, and surface properties may be deteriorated. On the other hand, if the content is less than 0.2 mass %, oxygen concentration may be high, number of inclusions may be increased, and cleanliness may be deteriorated. Therefore, it is set to be 0.2 to 1.0 mass %. It is desirably 0.4 to 0.9 mas % and more desirably 0.6 to 0.8 mass %.

### Mn: 1.0 to 2.0 Mass %

Mn is an important element since it combines S to form MnS thereby maintain machinability. Furthermore, it is an important element in order that MnO which decreases melting point is contained in inclusions. The action and effect cannot be exhibited sufficiently if it is contained less than 1.0 mass %. However, if it is higher than 2.0 mass %, hot workability may be deteriorated, and MnO content in oxide type inclusions may be increased. Therefore, it is set to be 1.0 to 2.0 mass %. It is desirably 1.1 to 1.9 mass %, and more desirably 1.2 to 1.8 mass %.

### Ni: 5 to 10 Mass %

It is an element essential for austenitic stainless steels, and an element stabilizing austenitic phase. 6 ferrite may be rapidly increased, hot workability may be deteriorated and the austenitic phase may not be stabilized if Ni is too low. Therefore, the lower limit is set to be 5 mass %. However, since Ni is an expensive element, the upper limit is set to be 10 mass %. It is desirably 7 to 9.5 mass %, and more desirably 8 to 9 mass %

### Cr: 15 to 20 Mass %

Cr is an element which is necessary to obtain corrosion resistance as austenitic stainless steel. However, if it is contained greater than 20 mass %, balance of δ/γ structure may be deteriorated and hot workability may be deteriorated. Therefore, it is set to be 15 to 20 mass %. It is desirably 17 to 19 mass %, and more desirably 18 to 18.5 mass %.

### Mo: 0.05 to 0.60 Mass %

Mo is an element which improves corrosion resistance. However, since it is a very expensive element, cost may be increased if it is contained excessively. Furthermore, Mo generates a phase which is a hard intermetallic compound with Cr and Fe, and deteriorates free-machining property of S-containing stainless steel. Therefore, it is set to be 0.05 to 0.60 mass %. It is desirably 0.10 to 0.58 mass %, and more desirably 0.20 to 0.55 mass %.

### Cu: 0.05 to 0.60 Mass %

Cu is an element which improves acid resistance, and effect thereof may be effectively obtained if Cu is contained at not less than 0.05 mass %. However, if it is added excessively, hot workability may be deteriorated. Therefore, Cu content is set to be 0.05 to 0.60 mass %. It should be noted that it is desirably 0.08 to 0.55 mass %, and more desirably 0.10 to 0.50 mass %.

Al: Not Greater than 0.005 Mass %

Al is a strong deoxidizing material, decreases oxygen concentration in molten steel, and has an effect to increase cleanliness. However, if oxygen in molten steel is decreased too much, since the reaction of the formula 3 is promoted to right direction and S in molten steel is moved to slag phase, S addition should be repeated. Furthermore, if Al is greater than 0.005 mass %, MgO—Al₂O₃ inclusion which have an adverse influence on surface properties may be easily generated. Therefore, Al content is set to be not greater than 0.005 mass %. It is desirably not greater than 0.004 mass %, and more desirably not greater than 0.003 mass %.

### S: 0.15 to 0.25 Mass %

S is an element which combines Mn in stainless steel so as to form MnS particles, and improves machinability by a tool. Since MnS particle is small, being not greater than 1 μm and is generated during solidifying process of S-containing stainless steel, it has no influence on cleanliness of the surface of products. The action and effect cannot be exhibited sufficiently if the S content is less than 0.15 mass %. On the other hand, if it is added excessively being more than 0.25 mass %, hot cracking susceptibility may be deteriorated. Therefore, the S content is set to be 0.15 to 0.25 mass %. It is desirably 0.155 to 0.20 mass %, and more desirably 0.160 to 0.175 mass %. Furthermore, in order to control S concentration accurately, the above-mentioned reaction formulae 1 to 3, which are arranged in terms of the deoxidation reaction and slag composition, are important.

### Ca: 0.0001 to 0.0035 Mass %

Ca is an effective element in order to control composition of non-metallic inclusions in steel to be CaO—SiO₂—Al₂O₃—MgO—MnO type oxide having good surface quality. The effect cannot be obtained if the content is less than 0.0001 mass %, and on the other hand, edge may be cracked during hot rolling if the content is more than 0.0035 mass %. Therefore, the Ca content is set to be 0.0001 to 0.0035 mass %. It is desirably 0.0002 to 0.0010 mass %.

Ca is a component which is mixed into molten steel by slag/metal reaction as shown in the formula 4. Ca concentration is related to deoxidation level, by controlling 0 and Si concentrations to be 0.002 to less than 0.008 mass % and 0.2 to 1.0 mass %, respectively, thereby enable controlling Ca content to be 0.0001 to 0.0035 mass %.

2(CaO)+Si=2Ca+(SiO₂) formula 4

In the above formula, element in the brackets indicates component in slag and element with under line indicates component in molten steel.
Mg: Not Greater than 0.0010 Mass %

Mg is a component which is inevitably mixed by erosion damage of refractory and reaction between slag/metal, as shown in the formula 5. It is desirable to reduce as much as possible since it is the main component of MgO—Al₂O₃ type inclusion which has adverse influence on surface quality. Therefore, it is set to be not greater than 0.0010 mass %. It is desirably not greater than 0.0009 mass %, and more desirably not greater than 0.0008 mass %. Mg concentration is related to deoxidation level, by controlling 0 and Si concentrations to be less than 0.0080 mass % and not greater than 1.0 mass %, respectively, thereby enable controlling Mg content to be not greater than 0.0010 mass %.

2(MgO)+Si=2Mg+(SiO₂) formula 5

In the above formula, element in the brackets indicates component in slag and element with under line indicates component in molten steel.
O: 0.0020 to Less than 0.0080 Mass %

0 concentration is a very important component in the present invention. If the O concentration is excessively high, number of oxide type inclusions may be large and surface defects may occur. On the other hand, if the O concentration is excessively low, since S in steel may be moved to slag phase via the reaction formulae 1 to 3, S yield may be deteriorated, and furthermore, accuracy of control of S concentration may be deteriorated. Therefore, the O concentration is set to be 0.0020 to less than 0.0080 mass % It is desirably 0.0025 to 0.0075 mass %, and more desirably 0.0030 to 0.0070 mass %.

### Oxide Type Inclusions

In the present invention, it is desirable that oxide type inclusions consists of at least one of CaO—SiO₂—MgO—Al₂O₃—MnO type inclusion and MgO—Al₂O₃—MnO type inclusion, CaO—SiO₂—MgO—Al₂O₃—MnO type inclusion contains MnO: 1 to 15 mass %, and furthermore, number of the MgO—Al₂O₃—MnO type inclusion is not greater than 50% in number ratio. Hereinafter basis for limiting components range and number ratio of each of oxide inclusions is explained.

CaO—SiO₂—MgO—Al₂O₃—MnO type inclusion

Basically, CaO—SiO₂—MgO—Al₂O₃—MnO inclusion has low melting point, and is stretched, divided and rendered fine during hot rolling thereby reduce scab damage caused by inclusions on the surface of products. Therefore, it is a desirable oxide type inclusion which should be controlled. In the present invention, each component range of CaO—SiO₂—MgO—Al₂O₃—MnO inclusion is CaO: 15 to 40 mass %, SiO₂: 15 to 50 mass %, and Al₂O₃: 5 to 35 mass %, and MgO: 5 to 3 mass %, and melting point of oxide composition having these component ranges is not greater than 1300 °C.

Furthermore, since MnO has an action to decrease melting point, it is desirable to contain it at not less than 1 mass %, more desirable to contain not less than 2 mass %, and further more desirable to contain not less than 3 mass %. On the other hand, if MnO is contained at not less than 15 mass %, MnO—SiO₂ inclusion may be easily crystallized in CaO—SiO₂—MgO—Al₂O₃—MnO inclusion. MnO—SiO₂ inclusion has high melting point, adheres on the surface of refractory of immerse nozzle used in continuous casting, becomes aggregation by sintering, is coarsened, and falls off, thereby cause coarsened oxide type inclusion which may be origin point of surface defect during hot rolling. It is an oxide inclusion which should be avoided. Therefore, the upper limit is set to be 15 mass %.

MgO—Al₂O₃—MnO Type Inclusion

MgO—Al₂O₃ is a compound which has comparatively wide solid solution range. Since MgO and Al₂O₃ become solid solution in ranges of 10 to 40 mass % and 60 to 90 mass %, respectively, these ranges are determined. MgO—Al₂O₃ type inclusion easily adheres on the surface of refractory of immerse nozzle used in continuous casting, becomes aggregation by sintering, is coarsened, and falls off, thereby cause coarsened oxide type inclusion which may be origin point of surface defect during hot rolling. It is an oxide inclusion which should be avoided. However, effect may be obtained in which liquid phase oxide of low melting point containing MnO is generated around MgO—Al₂O₃ type inclusion at 1600 °C of refining temperature, adheres on the surface of refractory of immerse nozzle and then does not form aggregation even by sintering thereby reducing coarsening, if MgO—Al₂O₃ type inclusion contains not less than 1 mass % of MnO. However, if MnO is contained more than 15 mass %, MnO and Al₂O₃ may generate compound of MnO—Al₂O₃, which may be crystallized in MgO—Al₂O₃—MnO type inclusion. Behavior of MnO—Al₂O₃ type oxide in molten steel is similar to that of MgO—Al₂O₃ type. MnO—Al₂O₃ oxide may easily adheres on the surface of refractory of immerse nozzle used in continuous casting, becomes aggregation by sintering, is coarsened, and falls off, thereby cause coarsened oxide type inclusion which may be origin point of surface defect during hot rolling. That is, in order to improve surface properties of products, MnO—Al₂O₃ type oxide is also an oxide type non-metallic inclusion which should be avoided. From the above-mentioned reason, MnO is set to be 1 to 15 mass %. Furthermore, even if Cr₂O₃ is contained not greater than 10 mass %, it may not have influence on properties of the above-mentioned MgO—Al₂O₃—MnO type inclusion.

Furthermore, from the above-mentioned reason, it is desirable that number of MgO—Al₂O₃—MnO type inclusion is not greater than 50% in number.

### MnO—SiO₂ Type Inclusion

Although MnO—SiO₂ type is not an object of oxide type inclusion of the present invention, it forms compound of high melting point such as MnSiO₃ or Mn₂SiO₄ at 1600 °C of refining temperature, adheres on the surface of refractory of immerse nozzle used in continuous casting, becomes aggregation by sintering, is coarsened, and falls off, thereby cause coarsened oxide type inclusion which may be origin point of surface defect during hot rolling. Furthermore, MnO—SiO₂ type inclusion is generated in a case in which deoxidation is not performed sufficiently and many oxide inclusions exist in molten steel. That is, MnO—SiO₂ type is an oxide type inclusion which should be avoided in order to improve surface properties of products.

### Method for Production

In the present invention, a method for production is also suggested, in which composition of oxide type inclusion is controlled to be a desirable composition, S yield is increased, and S concentration is accurately controlled. In an desirable embodiment of the present invention, first, after melting raw materials in an electric furnace, decarburization is performed in AOD or VOD, Mn is added, Cr reduction is performed using Si or Si+Al, slag basicity CaO/SiO₂ is controlled to be 0.75 to less than 1.00 by adding lime, and furthermore, MgO source is added, thereby forming CaO—SiO₂—MgO—MnO type slag in which MgO concentration of the slag is controlled to be 25 to 45 mass %. Reasons for limiting the slag basicity, MgO concentration and timing of Mn addition are explained as follows.

Slag Basicity: 0.75 to Less than 1.00

Basicity of slag has a large influence on equilibrium S concentration shown by the formula 3. The higher the slag basicity, the more the reaction shown by the formula 3 proceeds to the right, that is, S in molten steel may be moved to slag phase. Therefore, S can be maintained in molten steel as the basicity is low. However, if it is too low, being less than 0.75, that is, SiO₂ is high, deoxidation may become insufficient, and oxide type inclusion may be increased. Furthermore, S may excessively remain in molten steel, and S content may be high, being greater than 0.25 mass %. On the other hand, if the slag basicity is not less than 1.00, S may not be yielded in molten steel. Furthermore, effect can be obtained, in which deoxidation is promoted and oxygen concentration in molten steel is decreased. Number of inclusions may be reduced by decreasing oxygen concentration; however, if deoxidation is excessively promoted, composition of oxide type inclusion may become MgO—Al₂O₃ type oxide, and on the contrary, cleanliness of the surface of products may be deteriorated. Therefore, it is set to be 0.75 to less than 1.00 in the present invention. It is desirably 0.80 to 0.98, and more desirably 0.85 to 0.95.

### MgO Concentration in Slag: 25 to 45%

Under a condition in which slag basicity is 0.75 to less than 1.00, if MgO concentration of slag is controlled to be not less than 25 mass %, MgO is saturated in the slag, and solid consisting of MgO phase, MgO—SiO₂ phase and CaO—MgO phase is generated. By generating the solid consisting of MgO phase, MgO—SiO₂ phase and CaO—MgO phase in the slag, an effect is obtained in which CaO amount in liquid phase slag reacting with S in molten steel is decreased, and S added in the molten steel is easily yielded in the molten steel. That is, the reaction shown by the formula 3 is promoted to the right direction, since CaO amount in the liquid phase slag is small, CaS is saturated in the slag, the reaction will not proceed any longer. That is, by adding MgO, the added S becomes more likely to remain in the molten steel, and even if the oxygen concentration is lowered, the S concentration can be controlled quickly and accurately.

Furthermore, since MgO or MgO—SiO₂ phase and CaO—MgO phase are crystallized as solid phase, MnO concentration is relatively high in liquid phase. As a result, activity of MnO in the slag is also high, and it becomes possible to control inclusion composition to be CaO—SiO₂—Al₂O₃—MgO—MnO type inclusion which is harmless. However, if MgO concentration is more than 45 mass %, MnO content in CaO—SiO₂—Al₂O₃—MgO—MnO type inclusion and MgO—Al₂O₃—MnO type inclusion may be more than 15 mass %. Furthermore, the reaction of the formula 5 may be promoted to the right direction, and Mg concentration may exceed 0.001 mass %. Therefore, the MgO concentration is set to be 25 to 45 mass %. It is desirably 26 to 40 mass %, and more desirably 27 to 38 mass %. It should be noted that it is desirable that MgO source is added in AOD or VOD. In addition, although it is not limited in particular, it is desirable that recycled bricks containing MgO is used as MgO source. For example, MgO—C, magnesia-chrome or the like can be mentioned.

In addition, it is desirable that MnO concentration in slag is 0.5 to 3.0 mass % in order that oxide type inclusion of the present invention contains MnO appropriately.

### Timing of Mn Addition

Si, Mn, and Al can be mentioned as deoxidizing material for S-containing steel which is an object of the present invention, by adding Mn to molten steel first after decarburization, an effect can be obtained in which MnO is contained in CaO—SiO₂—Al₂O₃—MgO—MnO type inclusion or Al₂O₃—MgO—MnO type inclusion. By adding Mn first to the molten steel having high oxygen concentration after decarburization, Mn is oxidized, oxide type inclusion mainly containing MnO is generated in the molten steel, and MnO concentration in slag is also increased. Therefore, even if MnO is reduced by adding Si and Al after that, MnO in oxide type inclusion and MnO in the slag may remain. Therefore, it is desirable that Cr reduction is performed using Si or Si+Al after adding Mn. It should be noted that Fe—Mn alloy or metallic Mn is used as Mn, Fe—Si alloy or metallic Si is used as Si, and granular Al or Al rod is used as Al.

### EXAMPLES

Next, the configuration, action and effect of the present invention will be explained more clearly by way of examples; however, the present invention is not limited to the following examples. Oxygen blowing (oxidizing refining) was performed to remove C in AOD or VOD, and Cr reduction was performed by adding Fe—Mn alloy and Fe—Si alloy. After that, lime was added to adjust slag composition. Here, in addition to performing refining for the purpose of components adjustment, S was added. In this operation, FeS which had 30 mass % of pure S component was used as S source. After refining process in AOD or VOD, temperature was adjusted by ladle refining while stirring with Ar. Finally, slab was produced by continuous casting. It should be noted that weight of molten steel was 50 to 70 t and weight of slag was 4 to 6 t.

Each of the slabs which was produced was made to have a size of 1000 mm width×154 mm thickness×6000 to 8000 mm length. Each slab had their surfaces ground, was heated to 1200 °C, and was hot-rolled to produce a plate having a width of 1000 mm and a thickness of 3 mm. After that, annealing and acid washing were performed so as to remove surface scales. Furthermore, a plate after annealing was observed, using a visual inspection apparatus, surface defects of not less than 1 mm in length were evaluated.

Tables show chemical components of stainless steels obtained, composition of slags after finishing refining in AOD or VOD, composition of oxide type inclusions, number ratio of oxide type metallic inclusions, and evaluation results of surface quality and accuracy of controlling S concentration. Each evaluating method was as follows. It should be noted that values in brackets means out of the range of claims in the present invention. There are some values in bracket in Examples, they mean that they do not satisfy the range of dependent claim; however, they satisfy the range of independent claim.

1) Chemical components of alloy and composition of slag: Quantitative analysis was performed using an X-ray fluorescence analyzer, and the oxygen concentration of alloy was quantitatively analyzed using an inert gas impulse fusion infrared absorption method. Furthermore, when the slag was in a solid and liquid phase, the entire amount of the slag after casting was crushed, and samples were collected from the homogeneously mixed slag to analyze its composition.
2) Composition of oxide type inclusions: Immediately after beginning of casting, a sample collected from the tundish was mirror-polished and measured for inclusions with a size of 5 μm or more at 20 random locations using SEM/EDS. When the composition of inclusion was not uniform but consisted of two or more phases, it was evaluated based on the average composition.
3) Number ratio of oxide type metallic inclusions: From the measuring results in the above 2), ratio of number of MgO—Al₂O₃—MnO type oxide with respect to number of the total oxide type inclusions was evaluated.
4) Surface quality: Surface of plate of product was observed, surface defects of not less than 1 mm in length detected by visual inspection apparatus was measured, and ratings were determined as follows according to number of surface defects per 100 m.
⊚ (concentric circle means superior): Number of surface defects was not greater than 1 in 100 m
(which means good): Number of surface defects was 2 to 4 in 100 m
Δ (which means adequate): Number of surface defects was 5 to 7 in 100 m
x (which means inferior): Number of surface defects was not less than 8 in 100 m
   5) Accuracy of controlling S concentration: With respect to controlling adjustment in S concentration, evaluation was performed as follows.
⊚: S was added once in order to control S concentration to be within the target range
o: S was added twice in order to control S concentration to be within the target range
Δ: S was added three times in order to control S concentration to be within the target range
x: S was added four or more times in order to control S concentration to be within the target range, or S could not be controlled to be within the target range

TABLE 1

| | | Chemical components Remainder Fe | | | | | | | | | |
|---|---|---|---|---|---|---|---|---|---|---|---|
| | | mass % | | | | | | | | | |
| | | C | Si | Mn | Ni | Cr | Mo | Cu | Al | S | Ce |
| Exam- | 1 | 0.035 | 0.71 | 1.66 | 8.28 | 18.19 | 0.28 | 0.30 | 0.001 | 0.161 | 0.0003 |
| ples | 2 | 0.036 | 0.75 | 1.65 | 8.32 | 18.17 | 0.39 | 0.24 | 0.001 | 0.163 | 0.0002 |
| | 3 | 0.036 | 0.68 | 1.64 | 8.36 | 18.19 | 0.37 | 0.32 | 0.001 | 0.162 | 0.0002 |
| | 4 | 0.033 | 0.63 | 1.63 | 8.22 | 18.17 | 0.54 | 0.26 | 0.002 | 0.162 | 0.0002 |
| | 5 | 0.049 | 0.70 | 1.64 | 8.18 | 18.12 | 0.31 | 0.32 | 0.001 | 0.174 | 0.0002 |
| | 6 | 0.049 | 0.67 | 1.65 | 8.63 | 18.21 | 0.46 | 0.30 | 0.001 | 0.162 | 0.0002 |
| | 7 | 0.036 | 0.68 | 1.64 | 8.34 | 18.19 | 0.46 | 0.29 | 0.001 | 0.170 | 0.0002 |
| | 8 | 0.039 | 0.67 | 1.62 | 8.31 | 18.17 | 0.27 | 0.35 | 0.005 | 0.153 | 0.0004 |
| | 9 | 0.046 | 0.69 | 1.60 | 8.59 | 18.20 | 0.46 | 0.29 | 0.002 | 0.220 | 0.0001 |
| | 10 | 0.053 | 0.70 | 1.61 | 8.19 | 18.18 | 0.24 | 0.31 | 0.001 | 0.155 | 0.0002 |
| | 11 | 0.035 | 0.67 | 1.66 | 8.27 | 18.17 | 0.24 | 0.31 | 0.001 | 0.177 | 0.0002 |
| | 12 | 0.038 | 0.69 | 1.64 | 8.36 | 18.18 | 0.44 | 0.26 | 0.005 | 0.164 | 0.0001 |
| Compar- | 13 | 0.066 | 0.63 | 1.18 | 8.63 | 18.15 | 0.40 | 0.34 | 0.007 | 0.174 | 0.0001 |
| ative | 14 | 0.042 | 0.52 | 1.58 | 8.21 | 18.21 | 0.39 | 0.32 | (0.009) | 0.161 | 0.0011 |
| Exam- | 15 | 0.042 | 0.55 | (2.12) | 8.18 | 18.26 | 0.29 | 0.28 | 0.004 | 0.162 | 0.0002 |
| ples | 16 | 0.051 | (0.14) | 1.62 | 8.12 | 18.11 | 0.48 | 0.39 | 0.000 | 0.221 | (0.0000) |
| | 17 | 0.052 | 0.52 | 1.63 | 8.22 | 18.23 | 0.29 | 0.28 | 0.002 | 0.162 | (0.0042) |
| | 18 | 0.050 | (1.10) | 1.88 | 8.56 | 18.14 | 0.32 | 0.22 | (0.007) | (0.141) | (0.0036) |
| | 19 | 0.052 | 0.91 | (0.93) | 8.29 | 18.36 | 0.44 | 0.26 | 0.005 | 0.156 | 0.0012 |
| | 20 | 0.033 | (1.25) | 1.02 | 8.57 | 18.27 | 0.25 | 0.27 | 0.005 | 0.152 | 0.0018 |

| | | | | | Addition |
|---|---|---|---|---|---|
| | | Chemical components Remainder Fe | | | order of |
| | | mass % | | Steel production | deoxidizing |
| | | Mg | O | process | agent |
| Exam- | 1 | 0.0000 | 0.0047 | EF→AOD→LF→CC | Mn→Si |
| ples | 2 | 0.0000 | 0.0046 | EF→AOD→LF→CC | Mn→Si |
| | 3 | 0.0001 | 0.0056 | EF→AOD→LF→CC | Mn→Si |
| | 4 | 0.0001 | 0.0058 | EF→AOD→LF→CC | Mn→Si + Al |
| | 5 | 0.0000 | 0.0053 | EF→AOD→LF→CC | Mn→Si |
| | 6 | 0.0001 | 0.0043 | EF→AOD→VOD→LF→CC | Mn→Si |
| | 7 | 0.0003 | 0.0044 | EF→AOD→LF→CC | Mn→Si |
| | 8 | 0.0005 | 0.0022 | EF→AOD→LF→CC | Mn→Si + Al |
| | 9 | 0.0000 | 0.0078 | EF→AOD→LF→CC | Mn→Si |
| | 10 | 0.0007 | 0.0041 | EF→AOD→LF→CC | Mn→Si |
| | 11 | 0.0000 | 0.0044 | EF→AOD→VOD→LF→CC | (Si→Mn) |
| | 12 | 0.0006 | 0.0030 | EF→AOD→LF→CC | Mn→Si + Al |
| Compar- | 13 | 0.0002 | 0.0042 | EF→AOD→LF→CC | (Si + Al→Mn) |
| ative | 14 | (0.0018) | (0.0018) | EF→AOD→VOD→LF→CC | Mn→Si + Al |
| Exam- | 15 | 0.0010 | 0.0039 | EF→AOD→LF→CC | Mn→Si + Al |
| ples | 16 | 0.0000 | (0.0092) | EF→AOD→LF→CC | (Si→Mn) |
| | 17 | 0.0001 | 0.0077 | EF→AOD→LF→CC | (Si→Mn) |
| | 18 | (0.0012) | (0.0015) | EF→AOD→LF→CC | (Si + Al→Mn) |
| | 19 | 0.0009 | 0.0021 | EF→AOD→LF→CC | Mn→Si + Al |
| | 20 | (0.0011) | (0.0018) | EF→AOD→LF→CC | Mn→Si + Al |

TABLE 2

| | | Slag composition | | | | | | | Inclusion composition (wt %) acid number | | | | | |
|---|---|---|---|---|---|---|---|---|---|---|---|---|---|---|
| | | mass % | | | | | | | CaO—SiO₂—Al₂O₃—MgO—MnO type | | | | | |
| | | CaO | SiO₂ | Al₂O₃ | MgO | MnO | F | C/S | n | CaO | SiO₂ | Al₂O₃ | MgO | MnO |
| Exam- | 1 | 32.8 | 35.0 | 1.9 | 25.2 | 0.8 | 4.3 | 0.94 | 18 | 32.2 | 33.5 | 16.0 | 16.2 | 2.1 |
| ples | 2 | 32.1 | 35.5 | 1.7 | 27.3 | 0.8 | 2.6 | 0.90 | 20 | 24.3 | 35.2 | 12.1 | 14.5 | 13.9 |
| | 3 | 32.5 | 35.8 | 1.0 | 29.7 | 0.9 | 0.1 | 0.91 | 20 | 23.7 | 34.3 | 17.2 | 20.3 | 4.5 |
| | 4 | 31.3 | 33.8 | 2.8 | 28.1 | 0.9 | 3.1 | 0.93 | 16 | 24.1 | 32.2 | 18.4 | 14.3 | 11.0 |
| | 5 | 26.9 | 31.6 | 0.7 | 37.4 | 1.1 | 2.3 | 0.85 | 20 | 22.4 | 35.8 | 9.8 | 22.5 | 9.5 |
| | 6 | 31.3 | 34.9 | 1.3 | 30.7 | 0.9 | 0.9 | 0.90 | 20 | 23.1 | 36.5 | 13.4 | 19.2 | 7.8 |
| | 7 | 32.2 | 38.1 | 1.7 | 25.5 | 1.1 | 1.4 | 0.85 | 20 | 24.5 | 37.3 | 14.5 | 13.6 | 10.1 |
| | 8 | 38.0 | 33.1 | 1.8 | 25.2 | 1.0 | 0.9 | (1.15) | 9 | 33.2 | 19.5 | 12.8 | 22.7 | 11.8 |
| | 9 | 27.2 | 36.9 | 1.4 | 31.9 | 1.0 | 0.4 | (0.74) | 20 | 25.7 | 33.1 | 16.7 | 10.1 | 14.4 |
| | 10 | 22.1 | 27.0 | 0.9 | (45.7) | 2.2 | 2.1 | 0.82 | 12 | 27.5 | 24.2 | 11.5 | 20.7 | (16.1) |
| | 11 | 30.8 | 38.4 | 1.5 | (23.5) | 0.9 | 4.4 | 0.80 | 20 | 29.4 | 35.7 | 21.3 | 13.2 | (0.4) |
| | 12 | 27.0 | 28.5 | 2.5 | 40.4 | 0.8 | 0.8 | 0.95 | | | | | | |
| Compar- | 13 | 38.3 | 38.2 | 2.7 | (18.5) | 0.1 | 4.7 | (1.06) | 6 | 29.4 | 24.2 | 29.8 | 16.2 | (0.4) |
| ative | 14 | 34.2 | 29.8 | 5.2 | 29.1 | 0.7 | 1.0 | (1.15) | | | | | | |
| Exam- | 15 | 22.4 | 22.6 | 1.3 | (47.0) | 3.5 | 1.4 | 0.99 | 5 | 20.2 | 16.8 | 27.3 | 19.3 | (16.4) |
| ples | 16 | 25.3 | 35.2 | 1.5 | 31.3 | 0.9 | 5.8 | (0.72) | | | | | | |
| | 17 | 28.5 | 35.1 | 1.4 | 31.2 | 1.1 | 2.7 | 0.81 | 20 | 33.2 | 31.2 | 21.3 | 13.2 | 1.1 |
| | 18 | 35.2 | 29.5 | 0.5 | 22.2 | 0.6 | 12.0 | (1.19) | | | | | | |
| | 19 | 31.8 | 30.2 | 2.9 | 34.1 | 0.1 | 0.9 | (1.05) | 10 | 29.8 | 33.2 | 19.5 | 17.4 | (0.1) |
| | 20 | 31.4 | 32.1 | 1.8 | 29.3 | 0.9 | 4.7 | 0.98 | 3 | 26.7 | 31.5 | 28.8 | 11.7 | 1.3 |

| | | Inclusion composition (wt %) acid number | | | | | Number ratio of | | Accuracy of |
|---|---|---|---|---|---|---|---|---|---|
| | | MgO—Al₂O₃—MnO type | | | | | MgO—Al₂O₃—MnO | Surface | controlling S |
| | | n | MgO | Al₂O₃ | MnO | Cr₂O₃ | type inclusion | quality | concentration |
| Exam- | 1 | 2 | 28.2 | 80.1 | 9.7 | 2.0 | 10 | ⊚ | ◯ |
| ples | 2 | | | | | | 0 | ⊚ | ◯ |
| | 3 | | | | | | 0 | ⊚ | ⊚ |
| | 4 | 4 | 23.6 | 63.2 | 11.4 | 1.6 | 20 | ⊚ | ◯ |
| | 5 | | | | | | 0 | ⊚ | ⊚ |
| | 6 | | | | | | 0 | ⊚ | ⊚ |
| | 7 | | | | | | 0 | ⊚ | ◯ |
| | 8 | 11 | 25.8 | 60.5 | 8.3 | 5.4 | (55) | ◯ | Δ |
| | 9 | | | | | | 0 | ◯ | ◯ |
| | 10 | 8 | 22.5 | 62.1 | 13.5 | 1.9 | 40 | Δ | ⊚ |
| | 11 | | | | | | 0 | Δ | Δ |
| | 12 | 20 | 24.6 | 62.3 | 7.1 | 6.0 | (100) | Δ | ⊚ |
| Compar- | 13 | 14 | 33.1 | 66.3 | (0.2) | 0.4 | (70) | X | Δ |
| ative | 14 | 20 | 35.9 | 64.1 | (0.0) | 0.0 | (100) | X | X |
| Exam- | 15 | 15 | 23.1 | 59.8 | (15.5) | 3.6 | (75) | X | ◯ |
| ples | 16 | | | | | | — | X | ⊚ |
| | 17 | | | | | | 0 | X | ⊚ |
| | 18 | 20 | 35.2 | 64.8 | (0.0) | 0.0 | (100) | X | X |
| | 19 | 10 | 37.0 | 62.8 | (0.2) | 0.0 | 50 | X | X |
| | 20 | 17 | 31.2 | 68.5 | (0.3) | 0.0 | (85) | X | X |

In Examples 1 to 12, since they satisfied the range of the present invention, they had few surface defects, and they had no problem in accuracy of controlling in S concentration. In particular, since Examples 1 to 7 were in a desirable range, evaluation of surface defects and S concentration controlling accuracy were extremely superior.

Since C/S was high, being 1.15 in Example 8, it took time to control S concentration. Furthermore, addition amount of Al which was a deoxidizing material was large, the Al concentration was slightly high, being 0.005 mass %, oxygen concentration was low, being 0.0022 mass %, ratio of Al₂O₃—MgO—MnO inclusion was increased, and surface defects occurred.

Since C/S was low, being 0.74 in Example 9, deoxidation by Si could not be performed sufficiently, 0 concentration was high, being 0.0078 mass %, and as a result, number of oxide type inclusion was large and surface defects occurred.

Since MgO concentration in slag was high, being 45.7 mass % and amount of solid phase of the slag was large in Example 10, MnO concentration in the slag liquid phase was increased, and therefore MnO concentration in CaO—SiO₂—MgO—Al₂O₃—MnO type inclusion was high, being 16.1 mass %. Furthermore, crystallization of MnO—SiO₂ type inclusion in CaO—SiO₂—MgO—Al₂O₃—MnO type inclusion was also observed. As a result, evaluation of surface defect was A.

In Example 11, MgO concentration in slag was low, being 23.5 mass %, the slag was completely liquid phase during refining, yield of S was inferior and accuracy of controlling S concentration was inferior. Furthermore, MnO concentration was not concentrated in the slag since there is no solid phase in the slag, and MnO concentration in CaO—SiO₂—MgO—Al₂O₃—MnO type inclusion was low, being 0.4 mass % since Si which was deoxidizing material was first added and then Mn was added. As a result, evaluation of surface defect was A.

In Example 12, addition amount of Al which was deoxidizing material was large, furthermore, addition amount of MgO to slag was also large, and the MgO concentration in the slag was slightly high, being 40.4 mass %. As a result, ratio of MgO—Al₂O₃—MnO inclusion was high, and evaluation of surface defects due to oxide type inclusion was A.

On the other hand, Comparative Examples 13 to 20 were out of the ranges of the present invention. Hereinafter, each Comparative Example is explained.

In Comparative Example 13, MgO concentration in slag was low, being 18.5 mass %, the slag was completely liquid phase, and activity of MnO in the slag was not high, and furthermore, since Si and Al which were deoxidizing materials were added first and then Mn was added, the MnO concentration in the slag was low, being 0.1 mass %. As a result, oxide type inclusion obtained was MgO—Al₂O₃—MnO inclusion having MnO concentration of 0.2 mass %, and the inclusions were aggregated and coarsened on the inner wall of immerse nozzle during casting thereby cause large amount of surface defects. Evaluation of surface defects was x.

Mg concentration was high, being 0.0018 mass % in Comparative Example 14 since large amount of Al which was deoxidizing material was added, the Al concentration was high, being 0.009 mass % and Mg was added at the end of refining process. Therefore, oxide type inclusion obtained was MgO—Al₂O₃—MnO inclusion having MnO concentration of 0.0 mass %, and the inclusions were aggregated and coarsened on the inner wall of immerse nozzle during casting thereby cause large amount of surface defects. Evaluation of surface defects was x.

In Comparative Example 15, Mn concentration was high, being 2.12 mass % since Mn was excessively added. Furthermore, MgO concentration in slag was high, being 47.0 mass %, solid phase was increased, MnO activity in the slag liquid phase was increased relatively, and furthermore, MnO concentration in the slag was also high, being 3.5 mass %. Therefore, MnO concentrations in CaO—SiO₂—MgO—Al₂O₃—MnO type inclusion and MgO—Al₂O₃—MnO inclusion were high, being 16.4 mass % and 15.5 mass %, respectively. As a result, MnO—SiO₂ type inclusion was also generated in CaO—SiO₂—MgO—Al₂O₃—MnO type inclusion, and furthermore, MnO—Al₂O₃ type inclusion was also observed in MgO—Al₂O₃—MnO inclusion. Therefore, evaluation of surface defects was x.

In Comparative Example 16, addition amount of Si was small, the Si concentration was low, being 0.14 mass %, and furthermore, C/S of slag was low, being 0.72, deoxidation was not performed sufficiently, 0 concentration was high, being 0.0092 mass %, Ca was not mixed into molten steel by slag/metal reaction, and Ca concentration was low, being 0.0000 mass %. As a result, CaO—SiO₂—MgO—Al₂O₃—MnO type inclusion was not generated, and oxide type inclusion MnO—SiO₂ type which was not an object of the present invention was obtained. As a result of this inclusion generated, large amount of surface defects due to oxides occurred, and evaluation of surface defects was x.

Since Ca was added at the end of refining process in Comparative Example 17, the Ca concentration was high, being 0.0042 mass %. Oxide type inclusion was controlled to be CaO—SiO₂—MgO—Al₂O₃—MnO type inclusion by adding Ca; however, number of inclusions was increased since Ca was added, which had high deoxidizing ability into molten steel having high oxygen concentration. Furthermore, since the Ca concentration was high, edge cracking occurred during hot rolling. As a result, large amount of surface defects due to oxides occurred, and evaluation of surface defects was x.

In Comparative Example 18, addition amounts of Si and Al were large, the Si concentration was high, being 1.10 mass %, the Al concentration was high, being 0.007 mass %, and oxygen concentration was low, being 0.0015 mass %. As a result, Ca and Mg were reduced from slag, the Ca concentration and the Mg concentration were high, being 0.0036 mass % and 0.0012 mass %, respectively. In addition, since C/S of the slag was also high, being 1.19, large amount of S in molten steel was moved to the slag, and S was added repeatedly. However, the S concentration was low, being 0.141 mass %. Oxide type inclusion obtained was MgO—Al₂O₃—MnO inclusion having MnO concentration of 0.0 mass %, and the inclusions were adhered, aggregated and coarsened on the surface of refractory of immerse nozzle used during casting, and the coarse oxide type inclusion fell off thereby cause large amount of surface defects. Furthermore, since Ca concentration was high, hot workability was deteriorated and edge cracking occurred during hot processing.

In Comparative Example 19, addition amount of Mn was small, and the Mn concentration was low, being 0.93 mass %. Furthermore, MnO in slag was also low, being 0.1 mass %. As a result, MnO was not contained in oxide type inclusions sufficiently, the MnO concentration in CaO—SiO₂—MgO—Al₂O₃—MnO type inclusion and the MnO concentration in MgO—Al₂O₃—MnO type inclusion were 0.1 mass % and 0.2 mass %, respectively, and the inclusions were adhered, aggregated and coarsened on the surface of refractory of immerse nozzle used during casting, and the coarse inclusions fell off thereby cause large amount of surface defects.

In Comparative Example 20, Si was excessively added, and the Si concentration was high, being 1.25 mass %. As a result, deoxidation was promoted, and O concentration was low, being 0.0018 mass %. Mg was excessively supplied to molten steel, MnO concentration in MgO—Al₂O₃—MnO type inclusion was 0.3 mass %, and the inclusions were adhered, aggregated and coarsened on the surface of refractory of immerse nozzle used during casting, and the coarse inclusions fell off thereby cause large amount of surface defects.

### INDUSTRIAL APPLICABILITY

According to the technique of the present invention, by controlling composition of oxide type inclusion accurately and rendering the oxide type inclusion harmless, S-containing stainless steels having excellent surface properties can be provided.

1. A S-containing stainless steel consisting of, in mass %, C: not greater than 0.30%, Si: 0.2 to 1.0%, Mn: 1.2 to 1.8%, Ni: 5 to 10%, Cr: 15 to 20%, Mo: 0.05 to 0.60%, Cu: 0.05 to 0.60%, Al: not greater than 0.005%, S: 0.15 to 0.25%, Ca: 0.0001 to 0.0010%, Mg: not greater than 0.0010%, 0:0.0020 to less than 0.0080%, Fe as a remainder and inevitable impurities, wherein oxide type inclusions consists of at least one of CaO—SiO₂—MgO—Al₂O₃—MnO type inclusion and MgO—Al₂O₃—MnO type inclusion, and the MgO—Al₂O₃—MnO type inclusion contains MnO: 1 to 15 mass %.

2. The S-containing stainless steel according to claim 1, wherein among the oxide type inclusions, CaO—SiO₂—MgO—Al₂O₃—MnO type inclusion contains MnO: 1 to 15 mass %.

3. The S-containing stainless steel according to claim 1, wherein among the oxide type inclusions, number of the MgO—Al₂O₃—MnO type inclusion is not greater than 50% in number ratio.

4. The S-containing stainless steel according to claim 2, wherein among the oxide type inclusions, number of the MgO—Al₂O₃—MnO type inclusion is not greater than 50% in number ratio.

5. A method for production of S-containing stainless steel, when refining the S-containing stainless steel according to claim 1, comprising steps of:
melting raw materials in an electric furnace,
decarburizing in AOD or VOD,
adding Mn,
performing Cr reduction using Si, or both of Si and Al,
adding lime to control basicity of slag CaO/SiO₂ to be 0.75 to less than 1.00, and
adding MgO source to form CaO—SiO₂—MgO—MnO type slag in which MgO concentration in slag is controlled to be 25 to 45 mass %.

6. A method for production of S-containing stainless steel, when refining the S-containing stainless steel according to claim 2, comprising steps of:
melting raw materials in an electric furnace,
decarburizing in AOD or VOD,
adding Mn,
performing Cr reduction using Si, or both of Si and Al,
adding lime to control basicity of slag CaO/SiO₂ to be 0.75 to less than 1.00, and
adding MgO source to form CaO—SiO₂—MgO—MnO type slag in which MgO concentration in slag is controlled to be 25 to 45 mass %.

7. A method for production of S-containing stainless steel, when refining the S-containing stainless steel according to claim 3, comprising steps of:
melting raw materials in an electric furnace,
decarburizing in AOD or VOD,
adding Mn,
performing Cr reduction using Si, or both of Si and Al,
adding lime to control basicity of slag CaO/SiO₂ to be 0.75 to less than 1.00, and
adding MgO source to form CaO—SiO₂—MgO—MnO type slag in which MgO concentration in slag is controlled to be 25 to 45 mass %.

8. A method for production of S-containing stainless steel, when refining the S-containing stainless steel according to claim 4, comprising steps of:
melting raw materials in an electric furnace,
decarburizing in AOD or VOD,
adding Mn,
performing Cr reduction using Si, or both of Si and Al,
adding lime to control basicity of slag CaO/SiO₂ to be 0.75 to less than 1.00, and
adding MgO source to form CaO—SiO₂—MgO—MnO type slag in which MgO concentration in slag is controlled to be 25 to 45 mass %.
